(19) United States
(12) Patent Application Publication
(10) Pub. No.: US 2013/0244008 A1
(43) Pub. Date: Sep. 19, 2013

(54) Nanoporous to Solid Tailoring of Materials via Polymer CVD into Nanostructured Scaffolds

(71) Applicant: MASSACHUSETTS INSTITUTE OF TECHNOLOGY, Cambridge, MA (US)

(72) Inventors: Brian Lee Wardle, Lexington, MA (US); Fabio Fachin, Cambridge, MA (US); Karen K. Gleason, Cambridge, MA (US); Ayse Asatekin, Somerville, MA (US)

(73) Assignee: Massachusetts Institute of Technology, Cambridge, MA (US)

(21) Appl. No.: 13/803,415

(22) Filed: Mar. 14, 2013

Related U.S. Application Data
(60) Provisional application No. 61/611,610, filed on Mar. 16, 2012.

(51) Int. Cl. B05D 1/00

(52) U.S. Cl. CPC B05D 1/60
USPC 428/195.1; 427/255.6

(57) ABSTRACT

Method for tailoring permeability of materials. The method establishes a pattern of vertically aligned nanowires on a substrate and a physical shadow mask is provided to protect selected features of the pattern. A polymer is selectively infiltrated, using chemical vapor disposition, into interstices in the vertically aligned carbon nanotubes to establish a selected permeability. A cover over the infiltrated vertically aligned nanowires is provided.

This application claims priority to provisional application Ser. No. 61/611,610 filed on Mar. 16, 2012, the contents of which are incorporated herein in their entirety by reference.

This invention relates to devices and patterned structures of a material with regionally tuned porosity and method of making, and more particularly to a patterned array of vertically aligned carbon nanotubes selectively infiltrated with a polymer, deposited by chemical vapor deposition, to tailor the permeability of either all or certain regions of die porous material.

The efficient isolation of specific bioparticles in lab-on-a-chip platforms is important for many applications in clinical diagnostics and biomedical research. Such particles, including cells, bacteria, and viruses, can span more than three orders of magnitude in size. The majority of microfluidic devices designed for specific particle isolation are constructed of solid materials such as silicon, glass, or polymers. Such devices are hampered by some critical challenges; the low efficiency of particle-surface interactions in affinity-based particle capture, the difficulty in accessing sub-micron particles, and design inflexibility between platforms for different particle types. Existing porous materials, consisting mainly of two-dimensional porous membranes, or monolithic porous plugs, do not offer the structural properties or patterning capabilities to address these challenges.

Solid materials dominate as structural elements in microsystems including microfluidics, The inclusion of porous elements has thus far been limited to membranes sandwiched between Microchannel layers [1] or monoliths that fill the inside of channels [2]. With membranes, geometric control of the porous region is limited to two dimensions, and microscopic observation is usually possible only on the top side of the membrane. For porous monoliths, which can he fabricated from polymer or silicon, the porous region must be bounded on the sides by non-porous channel walls. Even with the limitations of these techniques, porous elements have found a wide mage of biological applications including filtation, solid phase extraction, microdialysis, enzyme microreactors, micromixers, and cell culture [3].

It is an object of the present invention to fabricate a porous structure having a selected permeability for use, for example, in microfluidics.

### SUMMARY OF THE INVENTION

According to a first aspect the method according to the invention for tailoring permeability of materials includes establishing a pattern of vertically aligned nanowires on a substrate and providing a physical shadow mask to protect selected features of the pattern. A polymer is selectively infiltrated, using conformal chemical vapor deposition (CVD), into interstices in the vertically aligned nanowires to establish a selected permeability. The nanowires may be carbon nanowires such as single-walled and multi-walled carbon nanotubes.

In a preferred embodiment, a cover is placed over the infiltrated vertically aligned nanowires. In this embodiment, the pattern of vertically aligned nanowires includes microfluidic channel walls. it is preferred that the polymer be a biocompatible polymer including, but not limited to, a silicone based polymer such as a polymer of trimethyltrivinylcyclotrisiloxane (V₃D₃) monomer. This copolymer is deposited by a CVD method that is tuned to maximize the conformality of the coating, to ensure the polymer infiltrates through into the pores as opposed to forming a surface coating. In a preferred embodiment, this step is performed by initiated CVD (iCVD), where a thermal free radical polymerization initiator and the monomer of interest is fed into a vacuum chamber that contains the vertically aligned nanowire structure and an array of heated wires. Oxidative CVD (oCVD) may also be used. Gaps between the vertically aligned nanowires are tailored from 100 nm down to zero after infiltration by modifying CVD process conditions and time. Polymer infiltration may be limited to a specific region of the substrate by masking the areas that are not desired to be infiltrated.

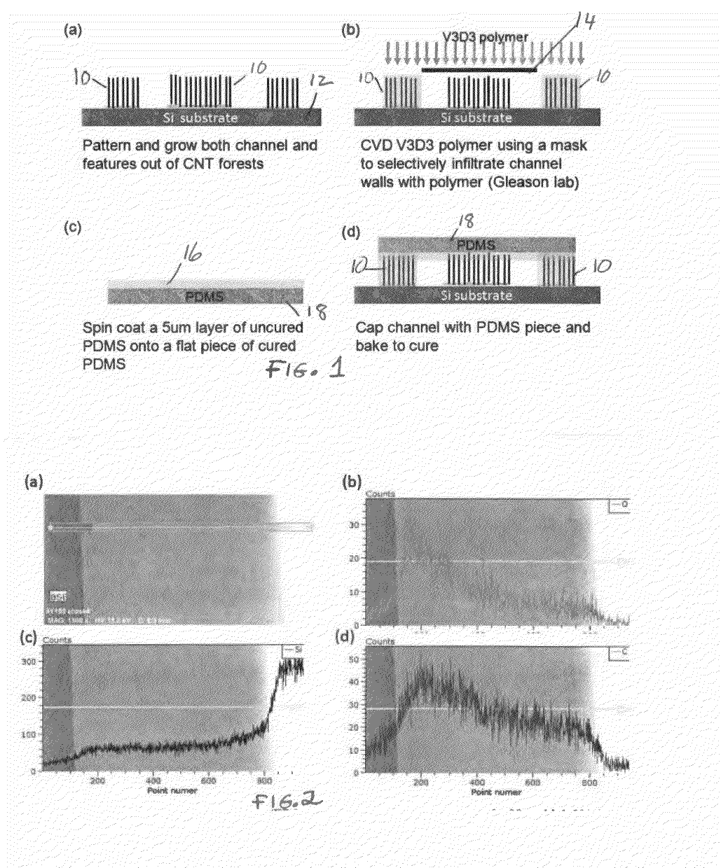

In another aspect, the invention is structure having a selected permeability comprising a pattern of closely spaced, vertically aligned nanowires extending from a substrate, the nanowires infiltrated with a polymer to tailor permeability. The nanowires may be carbon nanowires such as carbon nanotubes. Gaps between the nanowires do not exceed 100 nm. FIGS. 1a, b, c, and d are schematic illustrations showing the process for creating the materials of the invention with tailored permeability.

FIGS. 2a, b, c, and d are graphs of energy dispersive x-ray spectroscopy results for polymer infiltration of a 80 μm high vertically aligned carbon nanotube forest (VACNT). Every 100 points on the x-axis corresponds to 10 μum, and counts on the y-axis correspond to elemental concentration. FIG. 2a is a scanning electron microscope linage of the forest cross section. The substrate is on the right. FIG. 2b shows oxygen variation across the forest FIG. 2c illustrates silicon variation and FIG. 2d illustrates carbon variation.

### DESCRIPTION OF THE PREFERRED EMBODIMENT

A suitable method used for fabrication of the patterned VACNT forests has been previously described by Garcia et al. [4], Carbon nanotube growth may he performed, for example, in a four inch ID quartz tithe chemical vapor deposition (CVD) furnace (G. Finkenbeiner, Inc.) at atmospheric pressure using reactant gasses of C₂H₄, H₂ and He (Airgas, 400/1040/1900 SCCM). Catalyst annealing is carried out in a reducing He/H₂ environment at 650° C., leading to the formation of catalyst nanoparticles about 10 nm in diameter. C₂H₄ is then introduced into the furnace to initiate carbon nanotube growth, occurring at a rate of approximately 100 μm/min until the flow of C₂H₄ is terminated. The nanotubes grown using this method are multi-walled (2-3 concentric walls), with a diameter of around 8 nm. The foregoing description is merely exemplary.

The carbon nanotubes (CNT) are spaced by approximately 80 nm, thus yielding a 1 percent volume fraction of CNTs [5]. This fabrication method enables the creation of very high aspect ratio structures more efficiently tnan some state-of-the-art MEMS processes. For example, whereas deep reactive ion etching (DRIE) can create elements up to hundreds of microns deep at a rate of approximately 2-4 μm/min, this technique yields VACNT elements up to several millimeters in height at a rate of approximately 100 μm/min. The challenge with integrating VACNT elements into microfluidic channels is to create effective sealing so that there is no leakage of flow over the top of the elements (the bottom of the forest is already sealed to the silicon substrate). In the majority of application sit is desirable for flow to go around the VACNT features on either side. However, for certain applications, and or permeability measurements, one needs to create nanoporous filters that are well sealed on all sides.

The integration strategy depicted in FIG. 1 ensures top and side sealing of the VACNT element against the channel walls. As shown in FIG. 1a both channels and other features are patterned and grown forming vertically aligned carbon nanotubes forests. A vertically aligned nanotube 10 extends upwardly from a silicon substrate 12. The nanotubes 10 are grown to form a desired pattern in a forest of nanotubes.

With reference now to FIG. 1b, a CVD process is used to fill in the “walls” of the microfluidic channels by depositing a polymer onto the carbon nanotubes by highly conformal CVD. A shadow mask 14 protects selected features from infiltration, so the decreased porosity can be patterned in various ways, e.g., exposing “walls” of the nanochannel while protecting an inner “filter” that needs to remain of higher porosity, creating porous and filled channels over a continuous forest, etc. As shown, the polymer infiltrates the interstices of the forest of nanotubes 10. This step cannot be performed by the infiltration of a polymer dissolved in a solvent, as this can potentially affect the interactions between the carbon nanotubes and damage the structure of the device. CVD uses reactants in the vapor phase, and hence does not suffer from issues that arise from the surface tension of liquids.

Most CVD methods (e.g. plasma CVD) are not able to progress in the tight interstices of the VACNT element, which are ˜10 s of nm in effective width and microns and even millimeters in height. This high aspect ratio typically results in higher deposition rates at the top of the forest and limited infiltration of the bottom [8]. iCVD polymer coating, is selected to provide a desired permeability of the infiltrated structure from highly porous to solid. Short deposition times can result in VACNT with slightly decreased porosity, while longer deposition times can lead to essentially complete filling of the interstices between the CNTs and give an essentially non-pourous material. The choice of the polymer for this step depends on the requirements of the application. If the aim is simply to decrease the porousity to build walls for a microfluidic device for use with biological fluids, a biocompatible polymer is preferred. An example of such a polymer is the polymer of the V₃D₃ monomer [13], which is silicone based. V₃D₃ or other silicone-releated polymers are chemically similar to polydimethylsiloxane (PDMS) and hence may also aid in effective binding between the material and the lid. However, other alternatives are also possible. In another embodiments of this invention, a polymer of a specific functionality may be used to encourage or discourage wall-substrate interactions. Polymers suitable for use with oxidative CVD (oCVD) processing include poly (ethylenedioxythiophene) (PEDOT) and polypyrrole (PPY).

FIG. 1c illustrates the making of a top plate to cover the structure created in FIG. 2b. A thin layer of uncured PDMS 16 is spin coated onto a flat piece of cured PDMS 18. This structure is then placed on top of the infiltrated forest structure as shown in FIG. 1d.

It is noted that both the features and fluidic channel walls are made from patterned VACNT forests such that there is no gap between them. The permeability of the channel walls are then made significantly lower by selectively filling them with a polymer such as the polymer of V3D3, a silicone based polymer very similar to PDMS. Infiltration was performed using initiated chemical vapor deposition (iCVD), at the Massachusetts Institute of Technology [6,14]. The physical shadow mask 14 was laser cut from sheet acrylic.

Characterization results for the infiltration process are shown in FIG. 2. one can see from the energy dispersive x-ray spectroscopy (EDS) analysis that the PV3D3 polymer, which contains silicon and oxygen, has reached all the way into the bottom of the 80 μm tall forest down to the silicon substrate. An advantage of the technique disclosed herein is that the channel walls are intrinsically the same height as the VACNT features so no height matching is required.

After infiltration, the device is completed by the attachment of a PDMS ceiling as discussed above in conjunction with FIG. 1c. First, a flat piece of cured PDMS 18 2-3 millimeter thick is cut to the same size as the channel footprint with an inlet and an outlet punched out. Then uncured PDMS prepolymer 16 and a crosslinker are mixed at a 10:1 ratio and degassed inside a vacuum chamber. A drop of the mixture is placed on top of the cured PDMS piece and spun at 3000 rpm for 180 seconds, creating a 5 μm thick “glue” layer. The PDMS and glue are then placed on a 70° C. hot plate for six-seven minutes to increase the viscosity of the glue layer. Finally, the piece is placed onto the VACNT channel with the glue side down to complete the device, and then cured inside a 70° C. oven for another four hours to harden. This method attaches a flat ceiling to the open channel that had been formed by the polymer-filled CNT forests.

The fluid accessibility of a porous material is determined by its permeability which is defined by Darcy's Law, the constitutive equation of porous media flow [7]:

$$Q = \frac{- κ A Δ P}{μ L}$$

where Q [m³S⁻¹] is the volumetric flow rate, ΔP [Pa] is the pressure drop along the channel, A [m²] and L[m] are the cross-sectional area and length of the porous channel, μ[kg m⁻¹s^{31 1}] is the dynamic viscosity of the fluid, and Λ[m²] is the permeability of the porous media. Highly permeable materials are attractive for microfluidic applications as they minimize back pressure (ΔP) for a specific flow rate, requiring less powerful injection systems and allowing for lower specification (and lower cost) interconnects.

Experiments using the structures made according to the invention were conducted at the Massachusetts Institute of Technology in Cambridge, Mass. The experiments used rectangular forests surrounded by polymer infiltrated CNT channel walls. The devices are well sealed on all sides such that there is no low resistance leakage path around the forest. The rectangular VACNT elements (2 mm wide, 200 μm deep, 100 μm tall) were first wetted using a 0.5% TWEEN in DI water. A solution of 0.1% TWEEN in DI water was then injected for two minutes at a fixed inlet pressure of 2 psi and all the outlet flow connected into an Wppendorf tube. The volume of the collected outflow was measured and used to compute the flow rate which was then input to extract the permeability value Λ. Repeats were performed over five different devices to assess the variation across devices. Using this procedure, the fluidic Permeability of the VACNT structures was quantified as 5.4*10⁻¹⁴±8.3−10⁻¹⁵ m². We compared this value with the permeability measured using similar devices where the channel walls were constructed of patterned VACNTs but did not undergo polymer infiltration. Experiments show that without infiltration the permeability values obtained are much higher with a very large standard deviation. This resell suggests significant fluid leakage through the channel walls to give unreliable measurements. Thus we conclude that polymer infiltration is required to ensure that the fluid passes only through the desired nanoporous elements and not through the VACNT-based channel walls.

We compared the permeability of our VACNT forest with other micro and nanoporous materials from the scientific literature. Interestingly, this permeability value is comparable to or higher than that of other porous technologies with much large pore sizes. This result is somewhat counterintuitive as one would expect materials with larger pores to be more accessible to fluids. The large difference in permeability between VACNT elements and porous silicon is also not obvious, as these elements have similar pore dimensions. The high permeability of our VACNT forest can be explained, however, by classical analyses of the effect of porosity on permeability.

Further details of the present invention may be found in “Nanoporous Elements in Microfluidics for a Multi-scale Separation of Bioparticles,” Grace D. Chen, doctoral dissertation, Massachusetts Institute of Technology, June 2012, the contents of which are incorporated herein by reference in their entirety. It is noted that the numbers in square brackets in this specification refer to the references listed herein. The contents of these references are incorporated herein by reference in their entirety.

It is recognized that modifications and variations of the present invention will be apparent to those of ordinary skill in the art, and it is intended that all such modifications and variations be included within the scope of the appended claims.

### REFERENCES

1. WANG, P. C., D. L. DEVOE, AND C. S. LEE, Integration of polymeric membranes with microfluidic networks for bioanalytical applications. Electrophoresis, 2001, 22(18): p. 3857-3867.

2. YU, C., ET AL., Preparation of monolithic polymers with controlled porous properties for microfluidic chip applications using photoinitiatedfree-radical polymerization. Journal of Polymer Science Part a-Polymer Chemistry, 2002, 40(6): p. 755-769.

3. DE JONG, J., R. G. H. LAMMERTINK, AND M. WESSLING, Membranes and microfluidics: a review. Lab on a chip, 2006, 6(9): p. 1125-1139.

4. GARCIA, E. J., ET AL., Fabrication of composite microstructures by capillarity-driven wetting of aligned carbon nanotubes with polymers. Nanotechnology, 2007, 18(16).

5. WARDLE, B. L., ET AL., Fabrication and characterization of ultrahigh-volumejraction aligned carbon nanotube-polymer composites. Advanced Materials, 2008, 20(14): p. 2707-+.

6. VADDIRAJU, S. ET AL., Hierarchical Multifunctional Composites by Conformally Coating Aligned Carbon Nanotube Arrays with Conducting Polymer. Acs Applied Materials & Interfaces, 2009, 1(11): p. 2565-2572.

7. LEE, S. L. AND J. H. YANG, Modeling of Darcy-Forchheimer drag for fluid flow across a bank of circularcylinders, Iinternational Journal of Heat and Mass Transfer, 1997, 40(13): p. 3149-3155.

8. Alf, M. E.; Asatekin, A.; Barr, M. C.; Baxamusa, S. H.; Chelawat, H.; Ozaydin-Ince, G.; Petruczok, C. D.; Sreenivasan, R.; Teahaeff, W. E.; Trujillo, N. J.; Vaddiraju, S.; Xu, J. J.; Gleason, K. K. Advanced Materials 2010, 22, 1993.

9. Baxamusa, S. R; Gleason, K. K. Chemical Vapor Deposition 2008, 14, 313.

10. Baxamusa, S. R; Gleason, K. K, Thin Solid Films 2009, 517, 3536.

11. Asatekin, A.; Barr, M, C.; Baxamusa, S. H.; Lau, K. K. S.; Tenhaeff, W.; Xu. J, J,; Gleason, K. K, Mater Today 2010, 13, 26.

12. Asatekin, A.; Gleason, K. K. Nano Letters 2011, 11, 677.

13. O'Shaughnessy, W. S.; Gao, M. L.; Gleason, K. K. Langmuir 2006, 22, 7021.

14. Wardle, B. L. at al., United States published patent application US2010/0255303, Oct. 7, 2010.

What is claimed is:

1. Method for tailoring permeability of materials comprising:
establishing a pattern of vertically aligned nanowires on a substrate;
providing a physical shadow mask to protect selected features of the pattern; and
selectively infiltrating, using conformal chemical vapor deposition, a polymer into interstices in the vertically aligned nanowires to establish a selected permeability.

2. The method of claim 1 wherein the nanowires are carbon nanowires.

3. The method of claim 2 wherein, the carbon nanowires are carbon nanotubes.

4. The method of claim 3 wherein the carbon nanotubes are single walled or multiwalled carbon nanotubes.

5. The method of claim 1 further including providing a cover over the infiltrated vertically aligned nanowires.

6. The method of claim 1 wherein the pattern of vertically aligned nanowires includes microfluidic channel walls.

7. The method of claim 1 wherein the polymer is a biocompatible polymer.

8. The method of claim 1 wherein the polymer contains Si—O bonds.

9. The method of claim 1 wherein the polymer is infiltrated by initiated chemical vapor deposition (iCVD).

10. The method of claim 1 wherein the polymer is infiltrated by oxidative chemical vapor deposition (oCVD).

11. The method of claim 7 wherein the polymer is made from the monomer trimethyltrivinylcyclotrisiloxane (V3D3).

12. The method of claim 5 wherein the cover is FDMS polymer or quartz.

13. The method of claim 1 wherein gaps between the VACNT are tailored from 100 nm down to zero after infiltration.

14. Structure having a selected permeability comprising:
a pattern of closely spaced, vertically aligned nanowires extending from a substrate, the nanowires infiltrated with a polymer to tailor permeability.

15. The structure of claim 14 wherein the nanowires are carbon nanowires such as carbon nanotubes.

16. The structure of claim 14 wherein gaps between fee closely spaced nanowires do not exceed 100 nm.

17. The structure of claim 14 wherein the polymer is a biocompatible polymer.

18. The method of claim 10 wherein the polymer is poly (ethylenedioxythiophene) (PEDOT).

19. The method of claim 10 wherein the polymer is polypyrrole (PPY).
